(19) United States
(12) Patent Application Publication
(10) Pub. No.: US 2010/0061920 A1
(43) Pub. Date: Mar. 11, 2010

(54) PROCESS FOR PRODUCING STABLE FERRIC SALTS FOR WATER TREATMENT APPLICATIONS

(76) Inventors: Kevin Edward Janak, Ossining, NY (US); Levi James Grove, Bethlehem, PA (US)

Correspondence Address: ARTHUR J. PLANTAMURA, ESQ.;GENERAL CHEMICAL PERFORMANCE PRODUCTS LLC., 90 EAST HALSEY ROAD, PARSIPPANY, NJ, 07054, US

(21) Appl. No.: 12/207,649

(22) Filed: Sep. 10, 2008

(51) Int. Cl. C01G 49/10; C01G 49/14

(52) U.S. Cl. 423/493; 423/558

(57) ABSTRACT

A process is provided whereby a liquid ferrous sulfate or ferrous chloride solution containing 0.5-100% of the iron in the ferrous form (Fe²⁺) is oxidized in a continuous process using an ozone gas stream as an oxidant. The invention has advantages over prior art in that the process does not require additional elevated pressures (>1 atm), elevated temperatures, or additional liquid oxidant, and can be run in a continuous, rather than a batch process.

### FIELD OF THE INVENTION

The invention relates to the production of ferric sulfate (Fe₂(SO₄)₃) and ferric chloride (FeCl₃) solutions for water treatment applications.

### BACKGROUND OF THE INVENTION

Iron containing inorganic reagents such as ferrous sulfate, ferrous chloride, ferric sulfate, and ferric chloride are commonly used as flocculants and coagulants in municipal and industrial water and wastewater treatment. Both ferrous sulfate and ferrous chloride are generated in significant amounts as by-products of different production processes worldwide, including the production of titanium dioxide by the sulfate method or as waste steel mill pickle liquor. Although ferrous salts are used for a variety of purposes in the treatment of municipal and waste waters, such as for odor control, it is known that ferric salts tend to be more relatively effective in certain water treatment applications, such as for flocculation and coagulation and therefore tend to be desired over ferrous salts.

In the production of ferric salts, due to thermodynamic constraints, ferrous salts do not simply oxidize to the corresponding ferric forms, but require the expenditure of additional energy, often in the form of heat and pressure, to achieve oxidation. Further, very concentrated forms of the ferric solutions are also preferred, with levels typically in the range of 10-14% Fe. This adds an additional complication to the production of concentrated ferric salt solutions from some ferrous sources due to the need for additional acid, which would further dilute the iron content in the raw material. In this regard, a variety of processes have been developed and reported for the manufacture of ferric sulfate and ferric chloride chemical reagents for water treatment applications. U.S. Pat. No. 5,766,566 and Eur. Pat. No. 0 742 783 B1 describe a process for the preparation of solid ferric sulfate and, if desired, liquid ferric sulfate (LFS) via the formation of a slurry of ferrous sulfate, sulfuric acid, and, for LFS, water. The initial mixture is heated to 60-140° C., preferably 120° C., and pressurized with oxygen to 3-10 bar in order to oxidize the bivalent ferrous form of iron to its trivalent ferric form. In a similar process, U.S. Pat. No. 4,707,349 reports a high pressure process for the oxidation of ferrous sulfate to ferric sulfate. In this method of manufacture, iron oxides or iron metal is dissolved in sulfuric acid to produce a solution containing a high concentration of ferrous sulfate. The resulting solution is then subsequently oxidized in a two-step process. The first step of oxidation involves maintaining the solution temperature around 80-95° C. while under approximately 100 psi of oxygen pressure. The second stage of oxidation is conducted at approximately 54° C. using a non-molecular oxygen oxidizing agent such as hydrogen peroxide, chlorine dioxide, chlorine, or ammonium persulfate. In the case of hydrogen peroxide, a very concentrated solution is required if an iron concentration of 10-14% is desired. Further, catalysts such as copper sulfate or copper ammonium sulfate are used in order to improve the oxidation efficiency.

A similar process using high temperature, high oxygen or air pressure, and promoter ions, such as ammonium chloride, cupric chloride, and/or nickel chloride, for the production of ferric chloride form waste pickle liquor is described in U.S. Pat. No. 3,682,592 and U.S. Pat. No. 4,248,851. In addition, the use of solid phase beds for catalysts, such as manganese dioxide, have also been described (U.S. Pat. No. 1,606,470), albeit for dilute ferric sulfate solutions.

U.S. Pat. No. 2,306,425 describes a manufacturing process whereby a packed bed of metallic scrap iron is simultaneously reacted with sulfuric acid and oxidized with a SO₃/O₂ mixture to produce a liquid ferric sulfate.

A process for the production of ferric chloride via the reaction of scrap iron with HCl, followed by oxidation with oxygen gas and evaporation of water is described in WO 01/53206 A1. A preferred elevated temperature range of 150-180° F. is described, with the inventors noting that the rate of oxidation below 132° F. (50° C.) becoming too slow to make the oxidation feasible. In addition, higher concentrations are obtained in an economically prohibitive manner of evaporation of water via heat to increase the total iron concentration.

U.S. Pat. No. 4,507,273 reports a process for the preparation of ferric sulfate via partial dehydration of ferrous sulfate crystals in a fluidized bed at 40-65° C., followed by air oxidation at 150-300° C. The oxidized product is then acidified with sulfuric acid to produce a solid ferric sulfate product.

U.S. Pat. Nos. 5,118,849 and 5,547,637 describe the preparation of ferrous chloride with an iron source and hydrochloric acid, followed by oxidation of ferrous chloride solutions using chlorine gas at 50-100° C. and pressures ranging from atmospheric to 6 bar.

Manufacturing processes that do not require ferrous oxidation to the ferric iron valence state have also been reported, due to the use of high ferric content iron containing raw materials. For example, a high temperature (130-150° C.), high pressure (30-70 psi) process for the sulfuric acid dissolution of a ferric ore is described in U.S. Pat. No. 7,067,100 B2. Similarly, U.S. Pat. No. 7,387,770 describes a continuous process for the manufacture of liquid ferric sulfate via countercurrent reaction and flow of an iron ore slurry and sulfuric acid stream. However, the process requires high temperature (120-150° C.) and pressures (25-75 psi) to effect dissolution of the ore. No oxidation step is used since the ore only contains iron in its ferric form.

Another process for the manufacture of liquid ferric sulfate produced without pressure is described in U.S. Pat. No. 6,375,919 B1 via the reaction of boiling sulfuric acid solutions with an ore containing at least 30% FeOOH. In this report, however, the ferric ore is initially calcined at 200-600° C. in order to obtain the reported reactivity advantage.

These prior art processes suffer from the disadvantage of requiring either: i) very high temperatures, ii) high pressures, or iii) both high temperature and high pressure for the production of concentrated liquid ferric salt solutions and primarily as batch processes.

The provision of an economical, preferably continuous, process for the production of high iron concentration ferric salt solutions via the oxidation of ferrous salts to ferric salts at ambient to moderate temperatures without the need for high pressures is a desirable need. The high iron concentration ferric salt solution according to the invention, is achieved by reaction of ozone with high concentration ferrous solutions and/or slurries in a contact chamber with sufficient residence time in order to effect nearly complete oxidation of the ferrous iron. Although oxidation processes using ozone are known, none have been applied for the production of high concentration ferric salt solutions. For example, U.S. Pat. No. 4,176,061 describes a system for generating ozone and subsequent water purification. Additional processes using ozone for potable water treatment and purification are described in U.S. Pat. No. 5,851,407 and U.S. Pat. No. 5,888,403, with the former describing a process that includes limiting bromate formation. U.S. Pat. No. 6,517,729 B2 describes a process particularly applied for the oxidation of papermaking liquors.

### SUMMARY OF THE INVENTION

The invention involves the production of ferric sulfate and ferric chloride solutions suitable for use in water treatment applications. The resulting product is a fluid, clear solution that is stable with respect to precipitation for extended periods of time. Key characteristics of the invention include the production of an iron containing solution or slurry with 0.5-100% of the iron present in the ferrous form, obtained via, but not limited to, acid digestion of an iron ore containing ferrous iron, acid digestion of iron metal, dissolution of ferrous containing solids, or slurrying ferrous containing solids. The acid reactions are run in typical fashion, as known to those skilled in the art, without the need for additional pressures or temperatures beyond the nature of the reaction.

The ferrous salts can be in the form of ferrous chloride or ferrous sulfate, or a combination thereof, as either a filtered solution or slurry. The resulting ferrous containing stream is then fed into either a series of tanks or packed bed columns and placed in contact with an oxygen/ozone gas stream at ambient temperature and pressure in order to produce concentrated ferric chloride or ferric sulfate salt solutions. The gas/liquid streams can be fed either co-currently or counter-currently, depending on the desired reaction design sequence. The flow rates of both the liquid/slurry stream and gas stream are a function of a combination of factors: i) the initial ferrous concentration in the liquid/slurry stream, ii) the final desired ferrous concentration, iii) the available contact volume for the manufacturing process. Adjustment of these parameters can be readily made in order to produce a product of the type of quality described herein. The features and advantages of the present invention utilize the strong oxidizing potential of the ozone/oxygen gas mixture in order to produce concentrated ferric sulfate and ferric chloride solutions via a continuous flow process without the need for additional heat or high pressure reactions. Hence, the invention provides a process by which concentrated ferric salt solutions can be efficiently and economically prepared.

### BRIEF DESCRIPTION OF THE FIGURES

FIG. 1 illustrates the overall ferrous oxidation process and system in accordance with the countercurrent flow embodiment of the present invention.

FIG. 2 illustrates the overall ferrous oxidation process and system in accordance with the parallel flow embodiment of the present invention.

FIG. 3 illustrates the overall efficiency of the ferrous oxidation process and system via measurement of the residual ferrous content of the final liquid ferric product solution.

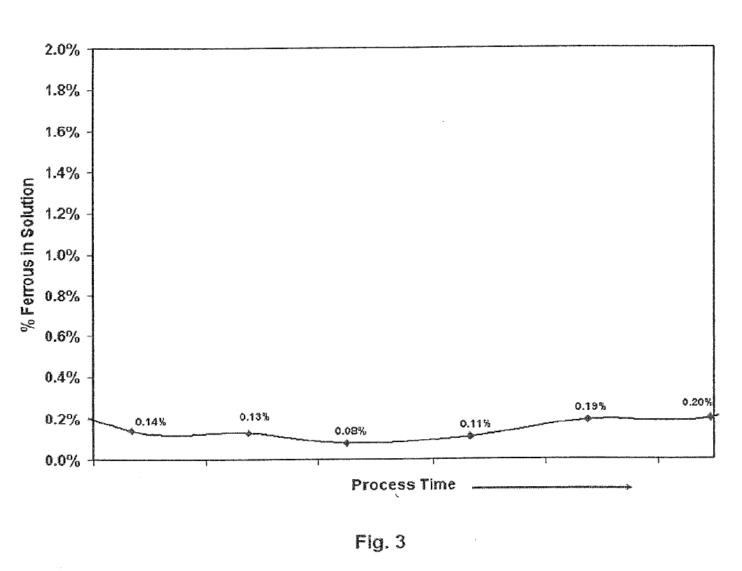

### DETAILED DESCRIPTION OF THE INVENTION

In the preferred embodiment of the invention, the production of an iron containing solution or slurry with 1-100% of the iron present in the ferrous form, is obtained via, but not limited to, acid digestion of an iron ore containing ferrous iron, acid digestion of iron metal, dissolution of ferrous containing solids, or slurrying ferrous containing solids. The acid reactions are run in typical fashion, as known to those skilled in the art, without the need for additional pressures or temperatures beyond the nature of the reaction. The acid concentrations can range from 10-100%, depending upon the desired concentration, the nature of the acid used, and desired composition of the final ferric salt solutions. The resulting ferrous containing streams may be oxidized directly or filtered, depending upon the preferred execution of the disclosed invention process. For ferric sulfate production, the mass ratio of the iron to sulfate in the precursor solution is preferably 0.20-0.50, more preferably 0.23-0.46, most preferably 0.35-0.41. In a similar fashion, the mass ratio of the iron to chloride in the precursor solution for ferric chloride production is preferably 0.25-0.79, more preferably 0.35-0.63, most preferably 0.47-0.56. The preferred total iron concentration of the ferrous containing precursor solutions or slurries is 5-16%, more preferably 8-14%, most preferably 10-13%.

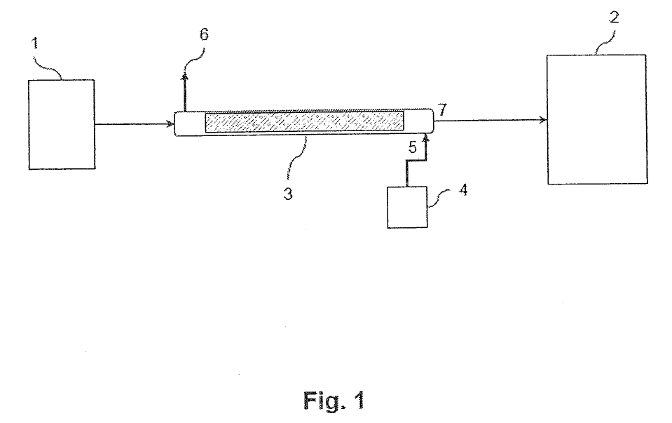

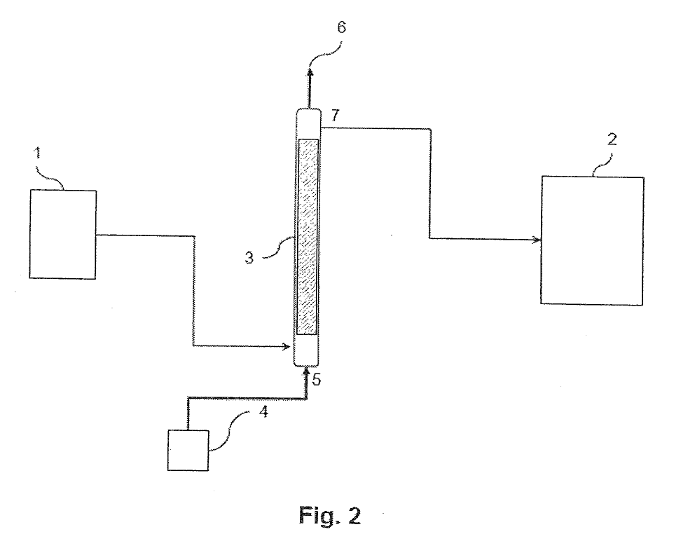

The ferrous ions in the precursor solutions or slurries are subsequently oxidized with an ozone gas stream. The ozone can be generated either via the use of oxygen or air, dependent on the desired throughput, coinciding the use of a standard, commercial ozone production unit. The inherent mass-transfer limitations of ozone gas into aqueous solutions are overcome by both an appropriate gas introduction system and mixing design. The ozone gas introduced to the precursor material via a suitably designed injection port or venturi is at a desired quantity equal to or greater than the desired quantity of production of the ferric salt solution, preferably at least 1% by weight ozone, preferably greater than 3% by weight ozone, most preferably greater than 7% by weight ozone. The mode of gas flow introduction can occur via a parallel flow, a countercurrent flow, or a cross-flow manner, or a combination thereof. FIGS. 1 and 2 illustrate the general process of countercurrent and parallel flow examples, respectively, used either open or packed bed column reactors. The ferrous containing precursor material is prepared and/or stored in an appropriate tank 1. The slurry or solution is then pumped into a contact chamber 3 whereby an ozone generator 4 produces an ozone containing gas stream that is injected into the contact chamber at a specified point 5. The desired rates are governed by contact time and efficient gas-liquid mixing via use of a contact chamber providing an appropriate residence time and/or mixing elements including, but not limited to, impeller mixing, homogenization mixing, and static mixing elements. The total residence time of the ozone/ferrous salt containing mixture is that time necessary to oxidize the ferrous iron present, preferably to less than 0.5%, most preferably to less than 0.2%. The unreacted or inert gases are correspondingly released via an outlet valve 6, with the desired oxidized ferric product sent to storage tank 2. The process is readily monitored via measurement of the effluent ferrous iron content, either via colorimetric titration or ORP measurement. Adjustments in the relative flow rates of the influent liquid or gas streams can be controlled via signal feedback from the ORP and/or manual attenuation of the flow rates according to quality control analyses.

According to a further embodiment of the present invention, the dissolution process can be combined with the oxidation process in a manner whereby the acid dissolution reaction occurs in a continuous manner coupled to oxidation process. A portion of the final liquid ferric product exiting the liquid/gas mixing zone at valve 7 in FIGS. 1 and 2 could be diverted back to acid dissolution tank 1, co-mixed with an influent acid stream subsequently contacting an iron source. The iron source could be fed either as a slurry in order to maintain mass balance or use of excess iron along with an acid contact time maintained via an appropriate flow rate for concentration purposes. Ultimately, this would further streamline production processes whereby the entire manufacture would be subject to continuous processing.

### EXAMPLE 1

A ferrous containing precursor solution was prepared in the following manner: 561 g of Fe₃O₄ containing iron ore was combined with 1.34 L of water in a 4-L glass kettle equipped with an overhead paddle mixer. 597 mL of 93% sulfuric acid was added and the temperature maintained at 99-103° C. for 3 hr. The mixture was cooled and filtered, resulting in a solution with 12.7% total iron and 4.03% bivalent ferrous iron.

The 22° C. solution was then pumped continuously into a contact chamber wherein ozone gas containing 8% by weight ozone was discharged into solution in a countercurrent fashion with a 224 min residence time, resulting in a liquid ferric sulfate solution containing 12.4% total iron and 0.14% ferrous iron.

### EXAMPLE 2

A ferrous containing precursor solution was prepared in the following manner: 74 g of Fe₃O₄ containing iron ore was combined with 197 g of ferrous chloride and 194 mL of concentrated hydrochloric acid in a 1 -L glass kettle equipped with an overhead paddle mixer. The mixture was heated and the temperature maintained at 99-101° C. for 2 hr. The mixture was filtered, resulting in a solution with 12.8% total iron and 6.7% bivalent ferrous iron. The solution was then cooled to 22° C. and added continuously into a contact chamber wherein ozone gas containing 4% by weight ozone was discharged into solution in a countercurrent fashion with a 53 min residence time, resulting in a liquid ferric chloride solution containing 12.7% total iron and 0.14% ferrous iron.

### EXAMPLE 3

A ferrous containing precursor solution was prepared by slurrying 65 lbs. of a ferrous containing iron ore in 145 lbs. of charge water and transfer to a 50-gallon reaction vessel. 124 lbs. of 93% sulfuric acid was added and the temperature maintained at 93-103° C. for 3 hr. The resulting solution contained 11.5% total iron and 3.65% bivalent ferrous iron.

The slurry was then cooled via a heat exchanger to less than 40° C. and pumped continuously into a packed bed contact chamber wherein ozone gas containing 8% by weight ozone was discharged into solution in a co-current fashion, resulting in a liquid ferric sulfate solution containing 11.4% total iron and 0.18% ferrous iron.

The invention has been described in terms of both principal aspects of the process and particular embodiments. However, it would be apparent to those skilled in the art that various alternatives and substitutes may be applied from the disclosure herein provided. It will be understood, accordingly, that the invention is not to be limited to the details described herein, unless so required by the scope of the appended claims.

What is claimed:

1. A continuous method of preparing ferric solution selected from ferric sulfate and ferric chloride comprising:
a. introducing a ferrous liquid selected from ferrous sulfate and ferrous chloride having a total iron concentration greater than 5 percent by weight into a reaction contact zone; and
b. introducing and mixing an ozone containing gas having an ozone content of at least 1 percent by weight with said ferrous liquid in said reaction contact zone; and
c. reaching said mixture at a temperature of between about 95° C. and 100° C. for a period of between one and five hours to convert the ferrous liquid substantially to a ferric solution; and
d. cooling and filtering the reaction product to obtain a ferric solution containing at least 10% total iron.

2. The method of claim 1 wherein the ferrous liquid is ferrous sulfate having an iron to sulfate mass ratio of from about 0.22 to about 0.46.

3. The method of claim 2 wherein the iron to sulfate mass ratio is from about 0.35 to about 0.41.

4. The method of claim 1 wherein the ferrous liquid is ferrous chloride having an iron to chloride mass ration of from about 0.35 to about 0.63.

5. The method of claim 4 wherein the iron to chloride mass ratio is from about 0.47 to about 0.56.

6. The method of claim 1 wherein the ozone containing gas introduced at step (b) has an ozone content is at least 3 percent by weight.

7. The method of claim 6 wherein the ozone content of the gas is at least 7 percent by weight.

8. The method of claim 1 wherein the introduction of the ferrous liquid and the ozone gas are introduced to said reaction contact zone in co-current flow.

9. The method of claim 1 wherein the introduction of the ferrous liquid and the ozone gas are introduced to said reaction contact zone in counter-current flow.
